(19) United States
(12) Patent Application Publication
(10) Pub. No.: US 2008/0231154 A1
(43) Pub. Date: Sep. 25, 2008

(54) Locking Systems

(75) Inventors: Dickory Rudduck, Chicago, IL (US); Geoffrey David Sizer, Chicago, IL (US); Edward David James Farren-Price, New South Wales (AU)

Correspondence Address: TELEZYGOLOGY, INC., 520 W. ERIE STREET, SUITE 210, CHICAGO, IL, 60654, US

(73) Assignee: Telezygology, Inc., Chicago, IL (US)

(21) Appl. No.: 11/814,149

(22) PCT Filed: Jan. 16, 2006
(86) PCT No.: PCT/AU2006/000045

§ 371 Date: Apr. 21, 2008

(30) Foreign Application Priority Data
Jan. 20, 2005 (AU) 2005900233

(51) Int. Cl. E05B 65/44

(52) U.S. Cl. 312/333; 312/223.6

(57) ABSTRACT

The invention provides a releasable fastening system particularly suitable for use in banks and similar institutions. The releasable fastening system is intended for use in conjunction with a storage unit having an opening element, such as drawer (18). The fastening system includes a latch means (38) and an engagement (34) for engaging the latch means (38). Also included is a bias means (44), biasing the opening element (18) to an opening position. Each of the latch means (38), the engagement means (34) and the bias means (44) is located internally of the storage unit when the opening element (18) is closed. The engagement means (34) is adapted to disengage the latch means (38) pursuant to a command.

### TECHNICAL FIELD

This invention relates to storage elements, especially cabinets, drawers, safety deposit boxes and similar storage units. The invention also relates to storage elements which may be networked with other storage elements.

### BACKGROUND ART

Traditionally, many storage units are provided with a locking mechanism to restrict access to the contents of the storage unit. For example, in offices, filing cabinets, drawers and stationery cupboards may be provided with keyed locks. In shops and similar commercial premises, drawers and cabinets may be provided with keyed locks. In banks and similar institutions, drawers and cupboards containing cash or valuable documents are provided with keyed locks or with combination locks and often with throw handles. Banks also usually contain safety deposit boxes having locks requiring two keys, one provided by the bank and the other by the customer.

In the case of storage units having combination locks and, usually, throw handles, these types of hardware are usually bulky and reduce the available space within the storage unit. In addition, the cost of such hardware is considerable.

If a key to a lock is lost, or if there has been a security breach and a key may have been stolen or copied without authority, it is necessary to have the combination of the lock changed. This normally requires the services of a skilled locksmith.

It would be desirable to provide types of storage units with locking mechanisms which did not require keyed locks, to alleviate the above problems.

Currently, most doors and drawer fronts of storage units include some type of handle hardware for gripping and opening the unit. The need to include the handle hardware adds to the cost of the storage units. In addition, storage units can be made more secure if they have no handle hardware or external features to assist opening. It is desirable to provide a locking system which can eliminate the need for handle hardware and which can allow the storage units to be provided with a streamlined appearance.

Situations occasionally arise where it is desirable to be able to provide a swift lockdown of a group of keyed storage units from a central location. Consequently, it would be desirable to provide a locking system which enables storage units to be networked, so that all may be locked or unlocked from a central location. It is further desirable to provide a networked locking system which permits individual storage units to be locked or unlocked from a central location.

Especially in security sensitive institutions such as banks, it is desirable to provide an audit trail, recording the identity of persons who have gained access to each storage unit. Therefore, it is desirable to provide a locking system which provides authorisation and verification for access and which can keep a record, identifying persons who have bad access.

These and other considerations are variously addressed by the present invention in its different embodiments.

### DISCLOSURE OF THE INVENTION

Accordingly this invention provides a releasable fastening system for a storage unit having an opening element, the fastening system including:
a latch means;
engagement means for engaging the latch means; and
bias means biasing the opening element to an opening position;
   wherein the latch means, engagement means and bias means are located internally of the storage unit when the opening element is closed and wherein the engagement means is adapted to disengage the latch means pursuant to a command.

In a preferred embodiment, this invention provides a releasable fastening system for a storage unit as above, which includes authorisation and/or verification means to authorise issue of the command.

In a further preferred embodiment, this invention provides a network of releasable fastening systems according to the invention, wherein the network includes a control centre for issuing the disengagement command.

The storage unit may be any suitable storage unit, including without limitation a drawer and carcase, a cupboard or a box, or any desired combination of these, such as a cupboard and one or more drawers. The opening element may be, for example, a door for a cupboard, or a drawer or a lid on a box.

The latch means and engagement means may be any suitable combination which can operate in accordance with the requirements of the releasable fastening system of the invention in its various aspects. By way of non-limiting example, reference is made to International Patent Application No PCT/AU2004/001580, (the “International Application”) the contents of which are imported herein by reference. The International Application discloses various types of fasteners. Especially preferred for the releasable fastening system of the present invention are the ring grip type fasteners disclosed in, for example, FIGS. 5 to 7, 8A to 8G and 9 and 10 to 13 of the International Application. Also preferred are the stud type fasteners disclosed in, for example, FIGS. 17 to 33 of the International Application. Also preferred are the in-line type of fasteners illustrated, for example, in FIGS. 41 to 46 and FIGS. 52 to 54 of the International Application.

Broadly, it is preferred that the latch means is a pin, which may also be described as a stud, having a groove and that the engagement means is adapted to engage the groove. It is to be appreciated, however, that other types of fastening systems may also fulfill the requirements of the latch and engagement means for the present invention.

The bias means is preferably a spring adapted to eject the drawer or open the door or lid, for example, when the latch means is disengaged from the engagement means.

The latch means, engagement means and bias means are located internally of the storage unit. The precise location depends on the nature of the storage unit. Where the storage unit is a cabinet or box, the latch means is preferably located on the door or lid and the engagement and bias means are preferably located on a nearby wall. Where the storage unit is a drawer in a drawer carcase, in one embodiment, the latch means is located on the rear of the drawer, with the engagement means and the bias means located on the carcase in an appropriate position. In another embodiment, if the drawer is equipped with a drawer slide assembly having a fixed part and an extending part, the latch means is preferably located on the extending part of the drawer slide and the engagement means and bias means are located in the fixed part of the drawer slide. This latter arrangement can have significant advantages in that the releasable fastening system of the invention can be provided already integrated into the drawer slide assembly.

The command may issue, for example, via a hard wired system or from a remote command module which may operate through the use of any suitable form of energy, including microwave, magnetic, electromagnetic, sonic, infrared, radio frequency and so on. Examples of these are disclosed in the International application and in International Patent application Nos PCT/AU99/00185 and PCT/AU2003/000759, the contents of both of which are imported herein by reference. Other methods of issuing commands may also be appropriate.

With regard to the second aspect of the invention, the authorisation and verification means may comprise or include any such suitable means which is already known or which may become known in the future. By way of non-limiting example, these may include a password or other identifying information, such as an account number, a biological identification, such as a scan of a fingerprint, face or retina, a voice recognition or any combination of any such means.

In relation to the third aspect of the invention, the network may be formed in any desirable manner but preferably involves a hard wired network.

Preferably, a manual override is provided for the storage unit in each aspect of the invention, so that access can be gained to the releasable fastener should there be some type of failure of the normal manner of disengaging the latch. If a manual override is provided, it is preferred that a tamper-proof or tamper-evident means is also included.

Different types of manual override may be used. It is especially preferred that the manual override can be accessed from the front of the storage unit and an example is given in connection with the drawings, below. However, other arrangements are possible. For example, the manual override may be accessible from a side or rear of the storage unit. An example of a manual override accessible from the side of the storage unit is given in connection with the drawings, below.

Although not limited to this application, the invention in its various aspects is particularly suited for use as an under counter storage system or safety deposit box system in banks and similar financial institutions. In one embodiment, an under counter drawer system can include a keyless locking system for drawers and cabinets which can be controlled by an operator using a wireless fob. The fastening system can include user feedback regarding the engaged or disengaged state of each storage unit. When linked to a command centre, a plurality of such under counter drawer systems can be locked down on a system-wide basis, by command from the control centre or, if desired, by a command directed at the releasable fastening system on any of the storage units. This means that, for example, a bank teller can cause lock down of the whole system if a security breach has occurred or is imminent.

Individual users can require biological identification for every disengagement command to issue. This can conveniently be incorporated in the wireless fob, which can include, for example, a thumb print scanner on or near a button operating the engagement means by remote command.

Each fastening system can be linked to bank security and monitoring and control systems.

If wireless networking is used, there need be no power connection to the under counter drawer system storage units, which can help to reduce overall costs.

In a similar manner to the under counter drawer system example above, a safety deposit box system may include a keyless locking system for the safety deposit box door, with user control by wireless fob and user feedback regarding the engaged or disengaged state of the door. The wireless fob may also be programmed to provide access to a strong room in which the safety deposit boxes are stored. A suitable control system for authorisation and verification to enable access may be networked and connected to the bank security and monitoring and control systems. User authorisation and verification can be by way of biological identification means as mentioned above.

### BRIEF DESCRIPTION OF THE DRAWINGS

The invention will now be illustrated in accordance with certain non-limiting examples thereof, in connection with the accompanying drawings, in which:

FIG. 1 is a perspective view of a first embodiment of a storage unit having a releasable fastening system according to the first aspect of the invention, and including a first embodiment of manual override;

FIG. 2 shows in more detail an exploded view of the drawer component in FIG. 1;

FIG. 3 shows the embodiment of FIG. 1 with the cabinet element removed and showing some details of the manual override;

FIG. 4 shows in side view, partially broken away, a first embodiment of a releasable fastening system for the storage unit of FIG. 1, the fastening system incorporating a stud fastener, suitable for the drawer component of the storage unit in FIGS. 1 and 2;

FIG. 5 shows in side elevation, partially broken away, an embodiment of an in-line fastening system, suitable for the cabinet element of the storage unit in FIGS. 1 and 3;

FIG. 6 shows in diagrammatic form an embodiment of an integrated fastener system which could be located in the storage unit of FIG. 1;

FIG. 7 shows the integrated fastener system of FIG. 6 in enlarged detail;

FIG. 8 is a perspective view of a second embodiment of a storage unit having a releasable fastening system according to the first aspect of the invention, and including a second embodiment of manual override;

FIG. 9 is a sectional side view of the drawer unit which forms part of the storage unit in FIG. 8;

FIG. 10 shows in exploded perspective view a detail of the manual override in FIGS. 8 and 9;

FIG. 11 is a perspective view of a third embodiment of a storage unit having a releasable fastening system according to the first aspect of the invention;

FIG. 12 is a perspective view of part of a drawer from the storage unit of FIG. 11;

FIG. 13 is a block diagram showing an embodiment of a network of releasable fastening systems of the invention;

FIG. 14 is a block diagram detailing an electronic scheme for the storage unit of, for example, FIG. 1;

FIG. 15 is a block diagram illustrating an electronic scheme of a wireless fob;

FIG. 16 is a block diagram showing the electronics scheme for an embodiment of the invention applied to a safety deposit system; and

FIG. 17 shows in block diagram a detail of the embodiment in FIG. 16.

### DETAILED DESCRIPTION OF THE DRAWINGS

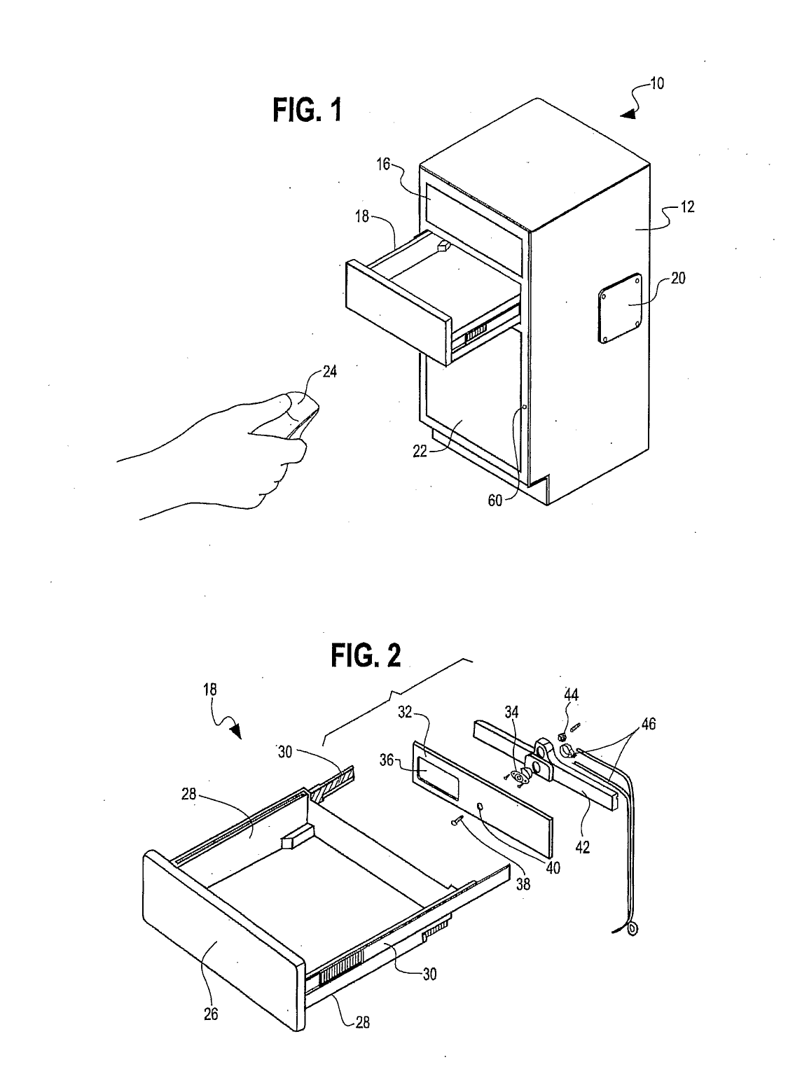

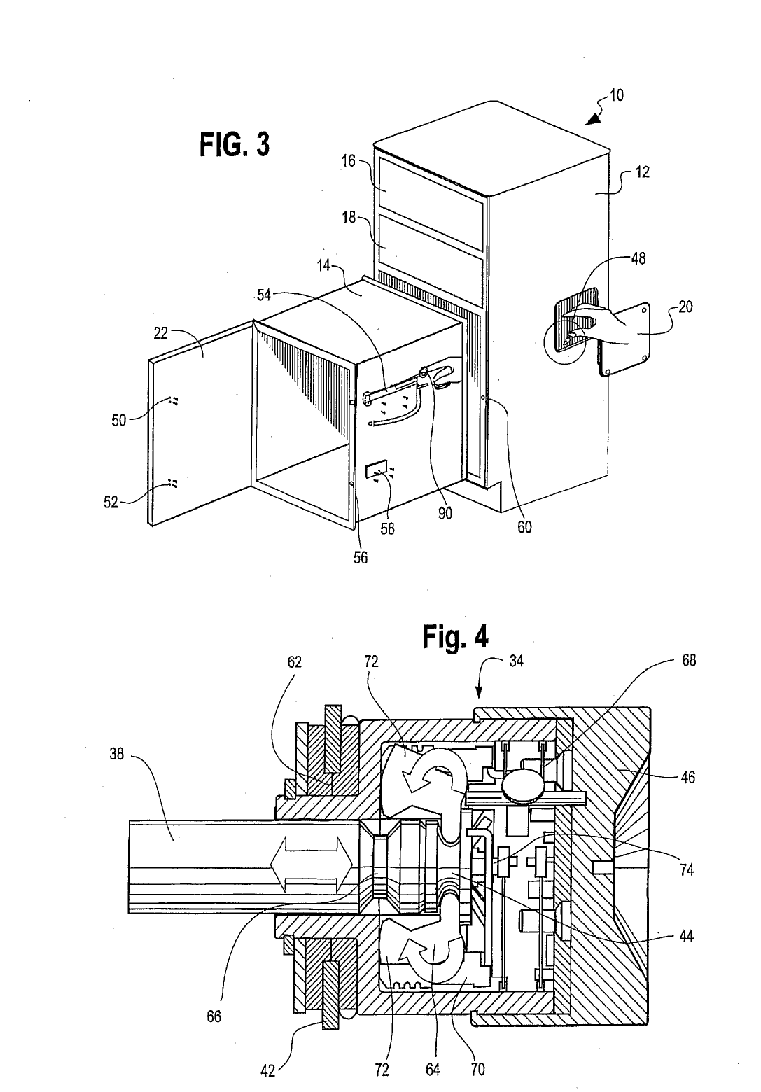

Referring first to FIG. 1, storage unit 10 has general carcase 12, cabinet sub-carcase 14 (see FIG. 3) and two drawers 16 and 18. Located on one side of carcase 12 is a manual override access hatch 20. Door 22 on cabinet sub-carcase 14 and drawers 16 and 18 are designed to spring open when the appropriate fastening system is issued with a disengagement command from key fob controller 24. Each of the fastening systems concerned is designed to lock when the drawer or lock is pushed manually to the closed position. Alternatively, each of these can be pushed to the closed position but not locked until an engagement command is issued from key fob controller 24 or from a central command centre (not shown).

FIG. 2 shows details of the drawer locking system for drawer 18. In this embodiment, drawer 18 has a sheet metal front 26 and it is to be noted that this does not have any key lock or drawer handle. When drawer 18 is in the closed position, it presents an attractive, streamlined appearance in storage unit 10 and does not present any means of gripping and manually opening the drawer.

Drawer 18 includes side wall mouldings 28 and drawer slides 30, one of which can be seen only partially in FIG. 2. Drawer back 32 is designed to tie together drawer side mouldings 28 and engagement means (ring grip or stud fastener) 34. Drawer back 32 includes aperture 36 for passage of items such as bank notes.

In this embodiment, stud 38 represents the latch means and is fixed through small aperture 40 in drawer back 32. Stud 38 is designed to be engaged by ring grip or stud fastener 34. Fastener 34 is received in fastener bracket and cable guide 42. Located behind bracket 42 is ejector spring mechanism 44 and mechanical override system 46 which can be accessed through hatch 20 as can be seen in FIG. 3. Hatch 20 includes tamper switch 48 to signal unauthorised access.

Details of locking of door 22 to cabinet carcase 14 are shown in FIG. 3. Carcase 14 is secured internally in storage unit 10. Located internally of door 22 is stud 50 designed to be engaged by in-line fastener 54. Peg 52 fits into aperture 56 and is designed to be ejected by door eject system 58 when fastening system 54, releases stud 50.

Storage unit 10 includes LED 60 which shows, for example, red when door 22 is locked and green when door 22 is released.

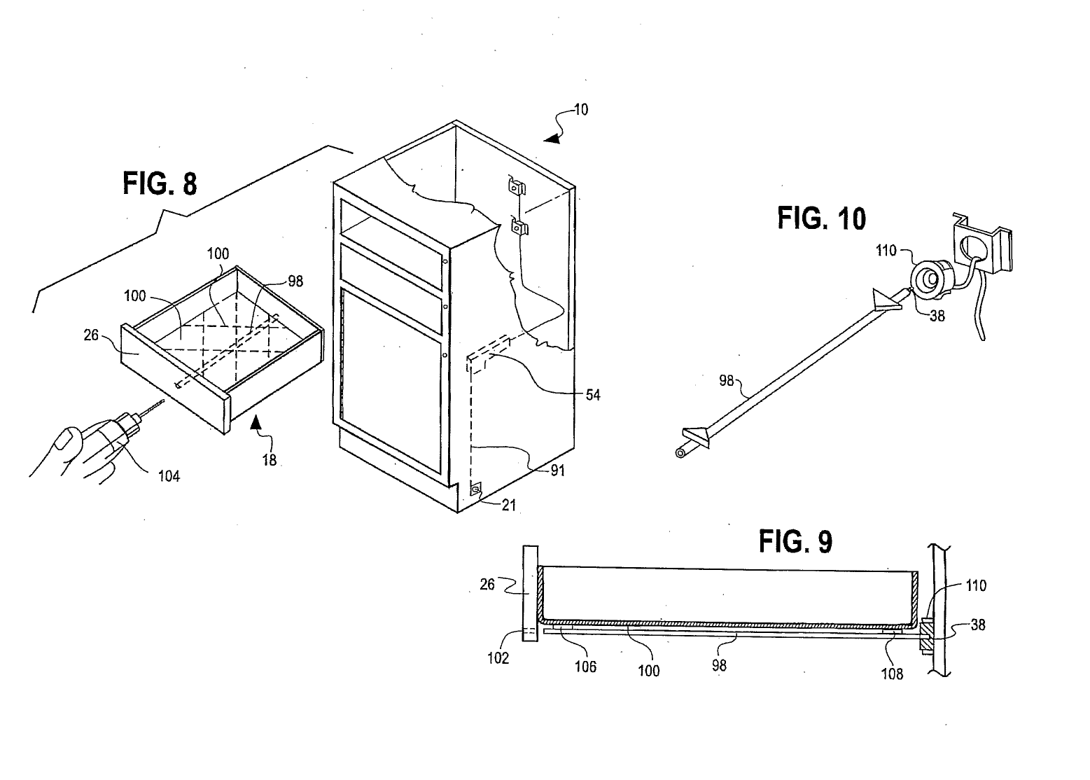

FIG. 4 shows details of fastener 34, in the form of a stud fastener, engaged to stud 38 for drawer 18 (or drawer 16 in FIG. 1). (Fastener 34 may also be, for example, a ring grip fastener, as illustrated in, for instance, FIGS. 8A to 8G in the International Application.) Stud fastener 34 includes isolation mount 62. Teeth 64 are designed to engage groove 66 in stud 38 in the engagement position. Shape memory alloy wire 68, when activated through sufficient heat, contracts to rotate shuttle 70, so that teeth 72 are located in apertures in shuttle 70 and teeth 72 disengage as shown in FIG. 4. Sensor 74 conveys information as to the engaged or disengaged state of fastener 34. Ejector spring mechanism 44 causes stud 38 and hence drawer 18 to open when stud 38 is disengaged. Manual override 46 is located at the rear of fastening system 34 as shown.

Further details of the operation of stud fastener 34 can be found in International Patent Application No PCT/AU2004/001580, as mentioned above.

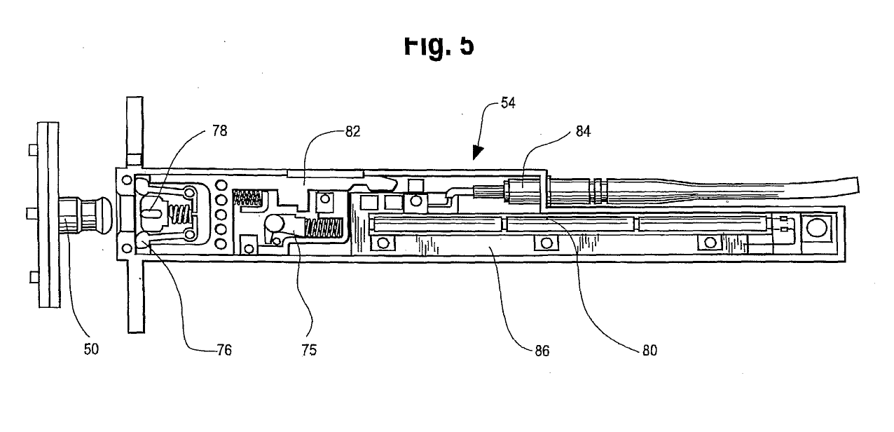

FIG. 5 shows details of in-line fastening system 54 for locking door 22 to sub-carcase 14 (FIG. 3). Stud 50 on door 22 is designed to be engaged by locking pawl 76 and to be ejected by ejector plug 78 when locking pawl 76 disengages stud 50. This occurs when shape memory alloy wire 80 is activated to contract in known manner, drawing shuttle 82 to the right as shown in the Figure, releasing locking pawl 76 and hence disengaging stud 50. Fastening system 54 includes cable connector 84 and electronic sub-assembly 86.

Further details of operation of in-line fastening system 54 can be found in International Patent Application No PCT/AU2004/001580, as mentioned above.

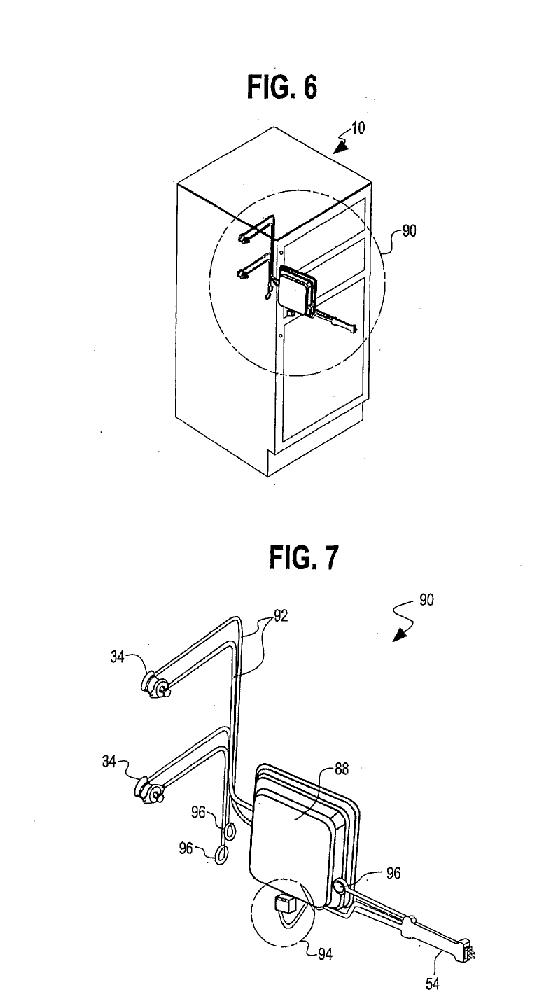

Referring now to FIGS. 6 and 7, integrated fastener system 90 is shown in FIG. 6 in position in storage unit 10. As shown in more detail in FIG. 7, integrated fastener system 90 includes an electronics module 88, two drawer fasteners 34 and one in-line fastener 54 for the cabinet door 22. Discrete wiring looms and override cables 92 are integrated into the rear of storage unit 10. An access hatch tamper switch 94 is attached to electronics module 88 to notify unauthorised access to override hatch 20 (see FIG. 3).

As will be apparent to one skilled in the art, if access hatch 20 is removed and override cables 92 are manually drawn—for example using finger loops 96, fasteners 34 or 54, as appropriate, can be released.

FIGS. 8, 9 and 10 show an alternative arrangement for manual override of fasteners 34. Each of drawers 18 has tube 98 bonded to the underside of drawer lattice 100. Tube 98 commences close to sheet metal drawer front 26, through which there may be drilled a corresponding aperture 102 (FIG. 9). Alternately, drawer front 26 may include a small indentation or mark to indicate the position in which drawer front 26 should be drilled by power drill 104 in order to access tube 98.

In this embodiment, tube 98 includes stud 38 and is attached to the underneath of drawer 18 at contact points 106 and 108.

Stud 38 is designed to snap into top hat bracket 110, where stud 38 is engaged in the manner of the ring grip fastener or stud fastener referred to above.

To release fastener 34, after accessing tube 98 through aperture 102 or drilling through drawer front 26, a thin rod (not shown) is inserted into tube 98 to manually release fastener 34 in a manner described in the International Application in connection with the in-line fastener, for example.

In this embodiment, cabinet fastener 54 may be manually released through access through a small access hatch 21, by drawing cable 91, in a similar manner as described in connection with FIG. 7, for example.

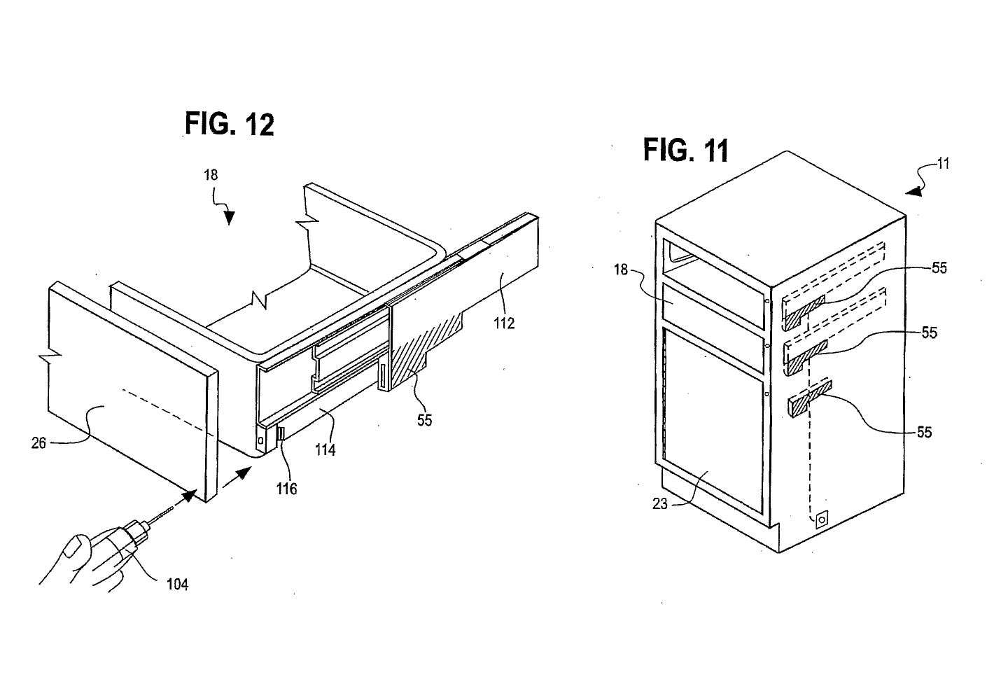

Reference is now made to the embodiment in FIGS. 11 and 12. In this embodiment, storage unit 11 has three identical fasteners 55. Two of these are integrated with drawer slides, as explained below. The third, for fastening door 23 of unit 11, is attached to a wall of unit 11.

As shown in FIG. 12, drawer 18 has a sheet metal front 26 as before. Drawer 18 may be a standard drawer, but is provided with a kit integrating fastener 55 into the drawer slide.

The drawer slide has a fixed part 112 and an extending part 114, which slides within fixed part 112. A stud 116 for fastener 55 is, as shown, attached to extending part 114. The engaging part of fastener 55 is attached to fixed drawer slide part 112. Thus, when drawer 18 is closed, stud 116 can engage in the engaging part of fastener 55. To open drawer 18, fastener 55 is released by a command as discussed above and as discussed further below.

In the case of any failure of fastener 55 to disengage, drill 104 can be used to drill through front 26 of drawer 18, to drill out stud 116. This is a simple form of manual override.

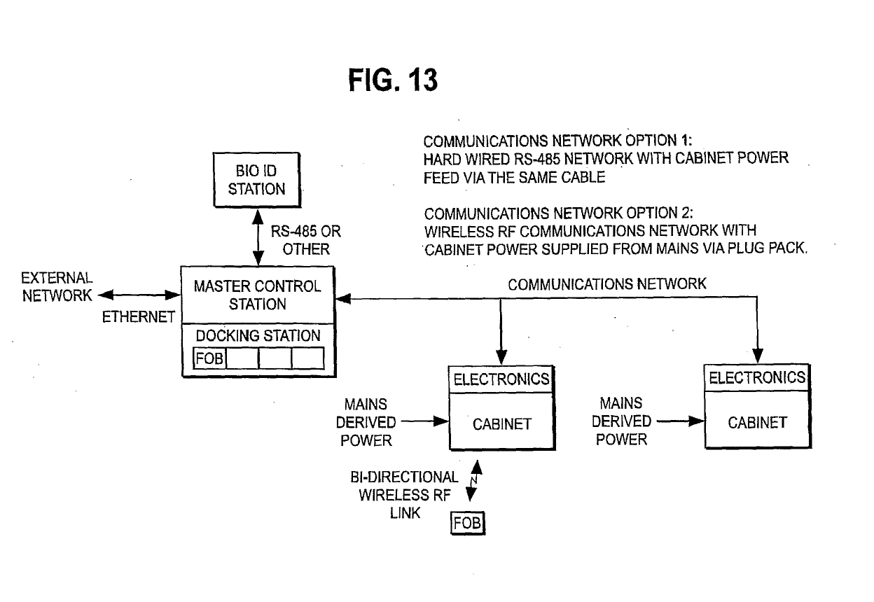

The block diagram in FIG. 13 depicts an embodiment of system implementation. As shown, each cabinet is equipped with an electronics module to control the fastening and user indication devices within the cabinet. Low voltage DC power for the electronics module is provided from a mains-powered plug pack, or may be fed via additional wires within the network cable in a RS-485 network (by way of example). The user can control the unlocking of drawers in the cabinet, using a multi-button bi-directional radio fob, which communicates with the cabinet electronics via short range (less than ten metre) radio frequency communications. Cabinets may be connected via a hard-wired RS-485 multi-drop network to a master control station, which can authorise unlocking operations and which can coordinate overall system operation. Alternately, a wireless network communications system may be substituted.

The master control station is shown with an optional fob docking station. This can provide facilities for fob programming (by direct electrical connection or short range wireless link) and for recharging of the fob battery.

Connected to the master control station is a bio ID station, which operators use to identify themselves to the system and to gain authorisation for access. When authorisation is granted, a fob may be programmed with the appropriate authorisation code and may be used subsequently by the operator to operate cabinet drawers and doors assigned to that operator. The master control station also communicates with the assigned cabinet, and can enable access using the authorised fob. By this method, the system can provide duplicated authorisation security paths.

The bi-directional radio fob is equipped with a button corresponding to each drawer and, if appropriate, to the cabinet. A bi-colour status LED should be associated with each button. To open a drawer of the assigned cabinet the operator presses the fob button which corresponds to that drawer. The fob can then communicate with the cabinet via the short range bi-directional radio frequency link, with access authorisation being granted by the cabinet electronics, following confirmation by communication between the cabinet and the master control station. Drawer status is communicated to the fob and indicated to the user by the fob LED which corresponds with that drawer.

Provision of a radio frequency link directly between the cabinet and fob (rather than from the fob to the master control station) allows the use of low power, short range communications. It could also allow implementation of a non-networked cabinet system, in applications which required a lower level of security.

The master control station may be networked with other computing devices, for example via a cable or wireless Ethernet network. This can allow control and monitoring of the master control station operation by other computers on the system. For example, the master control station could be allocated an IP address and communicate using TCP/IP protocol. Cabinet drawer status can be continually updated at the master control station, which can present this information to a security monitoring station connected to the Ethernet network.

System operations may include operator logon, drawer unlocking/locking, drawer opening/closing, lockdown events, alarms and faults. All of these may be maintained in a timestamped log on the master control station and perhaps other computers on the network. The fob may maintain a log which is uploaded by the docking station at end of day, for verification purposes. The cabinets can also maintain local logs as a backup.

Use of an RS-485 network to interconnect the master control station with the cabinets can provide the lowest per-unit electronics networking solution and allow significant separation between the master control station and the cabinets without radio frequency signal propagation difficulties, which may arise if a wireless network were used in this role.

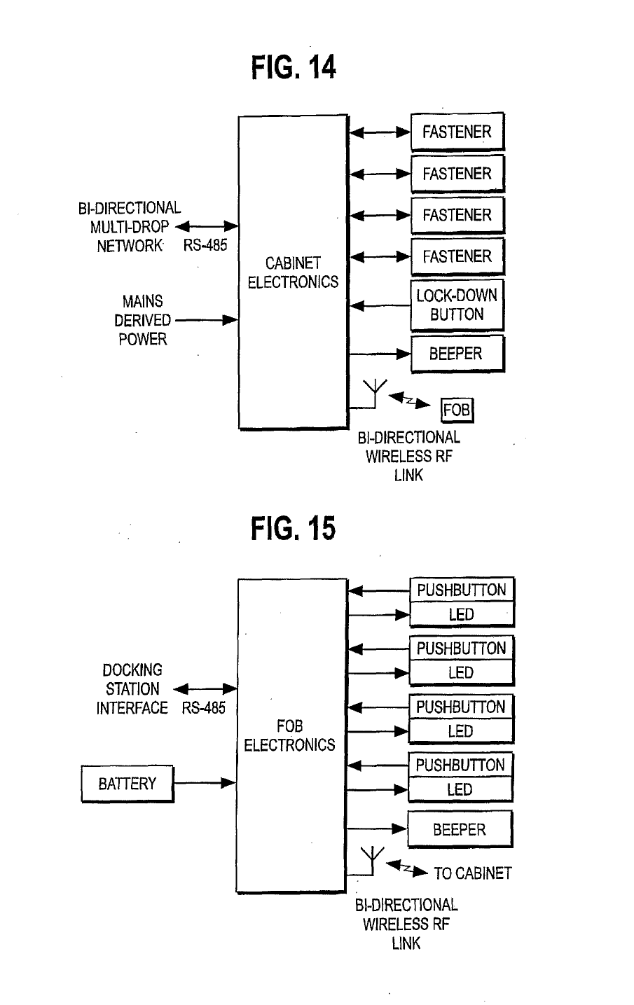

Cabinet electronics implementation is shown in the block diagram of FIG. 14. In this embodiment, a single electronics module within each cabinet interfaces with four fasteners (one for each of four drawers) and implements the standard fastener control and sensing functions (refer to the International Application). Power for electronics operation and fastener actuation is provided from a low voltage DC power source, such as a switchmode plug pack, which has sufficient capacity to power the fastener actuators.

The cabinet can communicate with the master control system via a bi-directional multi drop RS-485 network, using a protocol which may incorporate security provisions such as encryption. Each cabinet or storage unit may have a unique network address, to allow the master control station to selectively communicate with each cabinet or storage unit. The RS-485 network may be used to download access authorisation codes, is monitor cabinet status, undertake access authorisation handshake and monitor alarm conditions. In a wireless networking alternative, the RS-485 interface may be replaced by a wireless RF networking solution.

The cabinet may communicate with the fob using bi-directional short range radio frequency communications. This can allow the cabinet to receive commands to open drawers and act on those commands if authorised. The cabinet may also convey drawer status to the fob, for display on the status LED which corresponds with each cabinet drawer.

In this embodiment, the cabinet is fitted with an emergency “lock-down” button, which, when pressed, prevents the cabinet from being unlocked using any fob. Operation of the lock-down button may also be conveyed via the network to the master control station, which can then place all other cabinets in the network in the lock-down condition. Thus, if a bank teller, for example, is in a situation of threat, the bank teller may energise the lock-down button and cause lock-down for all cabinets on the premises.

The cabinet may also incorporate a beeper and/or one of more LEDs for status indication to the user.

In this embodiment, the cabinet electronics implementation is based on a moderate capability single chip FLASH programmed microcontroller, with RS-485 and short range wireless radio frequency communications interface, control and sensing facilities for four fasteners such as ring grip fasteners, lock-down button sensing, beeper and/or status LED control, and power protection/conditioning facilities. The radio frequency communications link with the fob may operate, for example, in the 902-928 MHz ISM band. The 2.4 GHz ISM band may also be considered.

In relation to the block diagram in FIG. 15, which depicts fob electronics, the fob is shown as providing a momentary action push button and corresponding bi-colour status LED for each of four drawers, a bi-directional short range radio frequency link for communications with the cabinet, an electrically connected communications interface for interfacing with the docking station and, optionally, a beeper for user indication functions. Power for the fob operation in this embodiment is provided by an internal rechargeable battery.

When plugged into the docking station, the fob is able to communicate with the master control station for downloading of access authorisation codes, and is connected to a power source of the fob battery.

The fob may communicate with the cabinet using bi-directional short range radio frequency communications. When the user is within communications range with the assigned cabinet and presses a button on the fob, the fob is able to communicate with the cabinet and, if authorised, to cause the drawer corresponding with that button to open. Drawer status is indicated on the corresponding fob bi-colour LED. Status can also be indicated via the fob beeper, if provided.

The fob electronics implementation may be based on a moderate capability single chip FLASH programmed microcontroller, with RS-485 and short range wireless radio frequency communications interfaces, sensing facilities for four push buttons, control facilities for four bi-colour LEDs and beeper if provided. Radio frequency operation is to be compatible with the cabinet. If a wireless network is used instead of interconnecting the master control station and cabinets using a hard-wired network, a wireless solution may be chosen. This may be custom designed or use 802.11, Bluetooth or Zigbee technology, for example.

In relation to the wireless link between fobs and the master control station, rather than having the fob communicate directly with the cabinet, the fob may communicate with the master control station via a wireless link, with cabinet control via the master control station. This may simplify cabinet electronics.

As will be apparent to one skilled in the art, there are many alternatives to the above embodiments, for example, providing a lock-down button on the fob rather than on the cabinet and providing a security alarm button on the fob, to trigger lock-down of the entire system. This can enhance personnel security and may avoid the need for operation of a security alarm at a fixed location. These are some only of the alternatives which may be built into the systems of the invention.

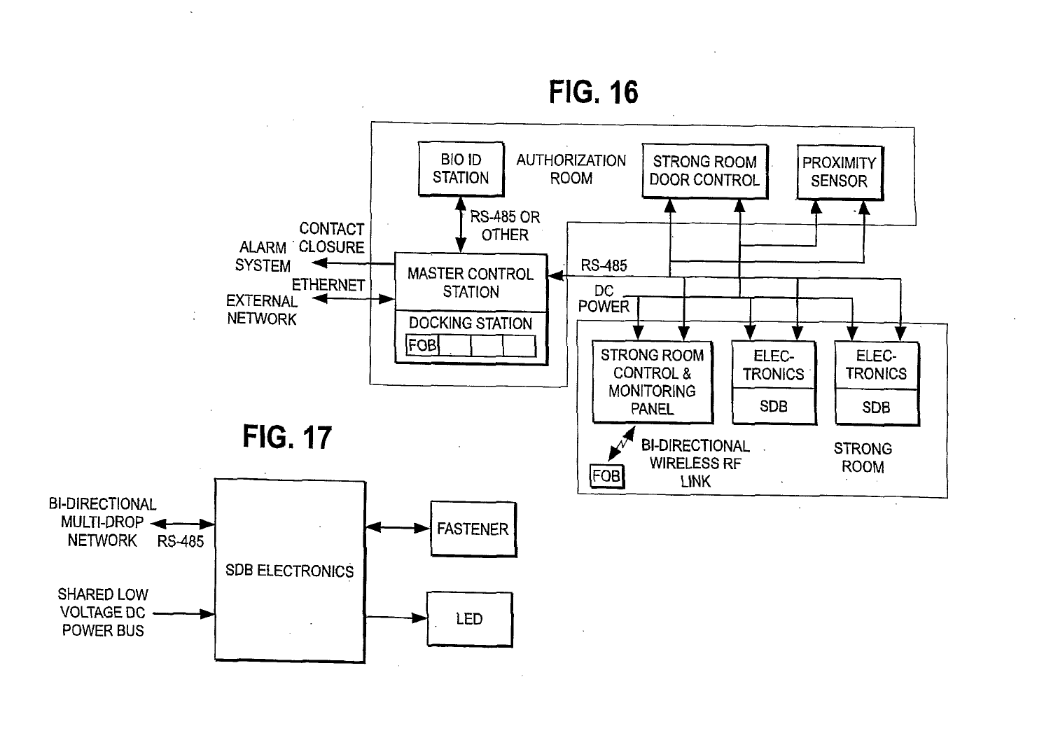

Turning now to FIG. 16, this shows, a block diagram for a safety deposit box system. This system may be regarded as an extension of the system described above, with the intention that a single integrated system can implement both functions concurrently.

As shown in the block diagram, each safety deposit box (SDB) is equipped with an electronics module which controls the fastening and user indication device (such as a LED) for that SDB. Each SDB is located within a strong room which includes a control and monitoring panel to provide short range bi-directional communications facilities, plus auxiliary functions such as an alarm and/or emergency push button, audible/visual indicators and movement sensor. Low voltage DC power for the electronics module and for fastener actuation may be reticulated by a local power bus which is provided from a mains-powered plug pack.

The user may control the unlocking of the SDB door using a multi-button bi-directional radio fob, which communicates with the control and monitoring panel via short range (less than 10 metre) radio frequency communications. The SDBs and the control and monitoring panel are connected via a hard-wired RS-485 multi-drop network to a master control station which authorises unlocking operations and coordinates overall system operation.

The master control station, docking station and key fob operation are generally as described in the previous embodiment.

The safety deposit box electronics are illustrated by the block diagram of FIG. 17. A single electronics module within each SDB interfaces with a single fastener which controls the SDB door and implements the standard fastener control and sensing functions. Power for electronics operation and fastener actuation is provided from a low voltage DC power source, such as a switch mode plug pack, which has sufficient capacity to power the fastener actuator. Power is reticulated to all SDB electronics modules within the strongroom via a shared power bus, which may include supplementary power devices such as an ultracapacitor or MiHM battery for each SDB on a modular basis.

Each SDB communicates with the master control via a bi-directional multi drop RS-485 network, using a custom communications protocol which incorporates security provisions such as encryption. Each SDB should have a unique network address, to allow the master control station to selectively communicate with each SDB. The RS-485 network is used to download access authorisation codes, monitor SDB status, undertake access authorisation handshake and monitor alarm conditions.

Incorporated in the SDB fastener may be a tamper detect function, which allows unauthorised entry into the SDB, for example, by forcing the door, to be detected and reported to the master control station. The SDB electronics implementation may be a cut-down version of that described above for the cabinet.

The fob may be identical to that described above in relation to the cabinet, or a cut-down variant of that fob.

It will be appreciated by one skilled in the art that various changes may be made to the various aspects of this invention without departing from the spirit or scope thereof.

### INDUSTRIAL APPLICABILITY

The releasable fastening system of the invention provides efficient, low cost and secure storage units especially suitable for use in banks and similar institutions. The invention can obviate the need for bulky hardware and eliminate the need for keyed locks.

When networked, the releasable fastening system of the invention can provide a superior level of security with a verifiable audit trail.

1. A releasable fastening system for a storage unit having an opening element, the fastening system including:
a latch means;
engagement means for engaging the latch means; and
bias means biasing the opening element to an opening position;
wherein the latch means, engagement means and bias means are located internally of the storage unit when the opening element is closed and wherein the engagement means is adapted to disengage the latch means pursuant to a command.

2. The releasable fastening system of claim 1, wherein the storage unit and opening element are chosen from the following:
a) the storage unit is a drawer and carcase and the opening element is the drawer;
b) the storage unit is a cupboard and the opening element is a door for the cupboard; and
c) the storage unit is a box and the opening element is a lid on the box.

3. The releasable fastening system of claim 1, wherein the latch means is a pin having a groove and the engagement means is adapted to engage the groove.

4. The releasable fastening system of claim 1, wherein the bias means is a spring.

5. The releasable fastening system of claim 1, wherein the latch means is adapted to be located on the opening element and the engagement means and bias means are adapted to be located on a non-opening element of the storage unit.

6. The releasable fastening system of claim 1, wherein the storage unit is a drawer and carcase and the opening element is a drawer provided with a drawer slide assembly having a fixed part and an extending part, and wherein the latch means is adapted for location on the extending part of the drawer slide, the engagement means and bias means being adapted for location on the fixed part of the drawer slide.

7. The releasable fastening system of claim 1, wherein the engagement means is adapted to disengage the latch means pursuant to a command issued through a hard wired system or from a remote command module.

8. The releasable fastening system of claim 7, wherein the remote command module is adapted to provide the command using energy chosen from microwave, magnetic, electromagnetic, sonic, infrared and radio frequency.

9. The releasable fastening system of claim 7, which includes means to indicate whether the latch means is engaged or disengaged by the engagement means.

10. The releasable fastening system of claim 9, wherein the indicating means includes a light emitting diode.

11. The releasable fastening system of claim 1, which includes authorisation and/or verification means to authorise issue of the command.

12. The releasable fastening system of claim 11, wherein the authorisation means is one or more of: a password, a code, an account number and a biological identification.

13. The releasable fastening system of claim 11, wherein the verification means is one or more of: a password, a code, an account number and a biological identification.

14. The releasable fastening system of claim 12, wherein the biological identification is one or more of: a fingerprint scan, a face scan, a retina scan and a voice recognition.

15. The releasable fastening system of claim 1, which includes a manual override for disengaging the engagement means from the latch means.

16. The releasable fastening system of claim 15, which includes means to indicate or prevent tampering with the manual override.

17. The releasable fastening system of claim 15, wherein the manual override includes a cable or tube.

18. The releasable fastening systems of claim 1, wherein the network includes a control centre for issuing the command.

19. The releasable fastening system of claim 18, wherein the engagement means in each of the releasable fastening systems in the network is adapted to engage the latch upon a command from the control centre.

20. The releasable fastening system of claim 18, wherein the engagement means in each of the releasable fastening systems in the network is adapted to engage the latch upon a command from the releasable fastening system of any storage unit having a networked releasable fastening system.

21. The releasable fastening system of claim 18, wherein the network includes log means.

22. The releasable fastening system of claim 21, wherein the log means is adapted to record one or more of: operator logon time, operator logoff time, latch disengagement time, latch engagement time, a lockdown event, an alarm and a fault.

23. The releasable fastening system of claim 18, wherein each storage unit is provided with a unique network address.

24. The releasable fastening system of claim 18, which includes a station for docking one or more of the remote command modules.

25. The releasable fastening system, wherein the docking station is adapted to communicate information to and from each remote command module.

26. The releasable fastening system of claim 24, wherein the docking station is adapted to provide energy storage for each remote command module.

27. (canceled)

28. (canceled)
